(19) United States
(12) Patent Application Publication
(10) Pub. No.: US 2014/0169148 A1
(43) Pub. Date: Jun. 19, 2014

(54) DISC PLAYER AND BURN-IN TEST METHOD FOR DISC PLAYER

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (TW)

(21) Appl. No.: 14/073,906

(22) Filed: Nov. 7, 2013

(30) Foreign Application Priority Data
Dec. 13, 2012 (CN) 2012105367323

(51) Int. Cl. G11B 27/36

(52) U.S. Cl. CPC G11B 27/36
USPC 369/53.11

(57) ABSTRACT

A disc player plays a test disc to perform a burn-in test. The disc player includes a driving unit, a timing unit, storage, an input unit and an output unit. The driving unit plays the test disc and generates a first timing signal when begin to play the test disc. The timing unit counts the duration of the burn-in test from a default value in response to the start signal. The storage stores the duration counted by the timing unit in real time. The input unit generates an output signal in response to a first user operation. The output unit outputs the stored duration in response to the output signal.

### BACKGROUND 1. Technical Field

The present disclosure relates to a disc player, and particularly to a burn-in test method for a disc player.

2. Description of Related Art

A disc player, such as a digital video disc (DVD) player, typically plays a disc and displays the playing time of the disc on a display. When the disc player has been manufactured, the disc player needs to perform a burn-in test to determine whether the disc player satisfies predetermined and expected standards. Generally, the method of the burn-in test is to enable the disc player to play a test disc for an extended period of time, such as 12 hours. A tester determines whether the burn-in test is finished by periodically viewing the playing time on the display. However, if the burn-in test is interrupted and the disc player stops playing and is powered off, the playing time on the display disappears. The tester may not timely view the playing time, and cannot accurately determine how long the burn-in test has lasted. Thus, the tester may need to run the burn-in test again, and this wastes a lot of time.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a function block diagram of a disc player in accordance with an embodiment.

FIG. 2 is a flowing chart of a burn-in test method in accordance with an embodiment.

### DETAILED DESCRIPTION

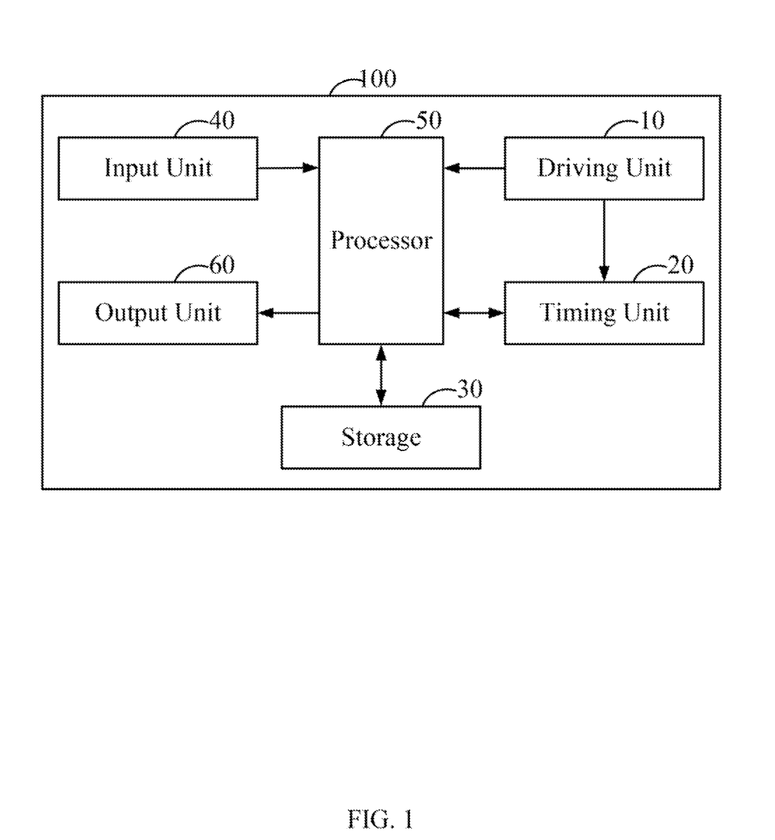

FIG. 1 shows a disc player 100 in accordance with an embodiment. The disc player 100 plays a test disc for a predetermined time to perform a burn-in test, and stores a duration of the burn-in test in real time, so a user can obtain the duration as needed. The disc player 100 includes a driving unit 10, a timing unit 20, storage 30, an input unit 40, a processor 50, and an output unit 60.

The driving unit 10 plays the test disc to perform a burn-in test. The driving unit 10 sends a start signal to the timing unit 20 and the processor 50 at the beginning of the burn-in test.

The timing unit 20 counts the duration of the burn-in test, and sends the duration to the processor 50 in real time. The timing unit 20 begins to count the duration from a default value in response to the start signal. In this embodiment, the timing unit 20 counts the duration from a default value of zero at the first time, and then the default value is set by the processor 50 in response to a user operation.

The storage 30 stores the duration of the burn-in test in real time under the control of the processor 50. The storage 30 is a nonvolatile memory, for example, an electrically erasable programmable read-only memory (EEPROM). Thus, the duration stored in the storage 30 will not be lost when the disc player 100 is powered off. In this embodiment, the storage 30 defines a global variable to record the duration of the burn-in test.

The input unit 40 generates different signals in response to different user operations. In this embodiment, the input unit 40 includes several function keys set on the disc player 100. The signals include an output signal, a setting signal and a reset signal. If the burn-in test is interrupted, the user may need to view the duration stored in the storage 30 to determine how long the burn-in test has lasted. In this situation, a first function key is manually pressed. The input unit 40 generates the output signal in response to the pressing of the first function key, and then sends the output signal to the processor 50. If the burn-in test is interrupted because of external malfunctions, the user needs to set the duration as the default value of the timing unit 20 to continue the burn-in test from the point of interruption. In this situation, a second function key is manually pressed. The input unit 40 generates the setting signal in response to the pressing of the third function key, and then sends the setting signal to the processor 50. If the burn-in test is interrupted by the malfunctions of the disc player 100 or the burn-in test has finished, the user may need to reset the duration stored in the storage 30. In this situation, a third key is manually pressed. The input unit 40 generates the reset signal in response to the pressing of the second function key, and then sends the reset signal to the processor 50.

The processor 50 controls the storage 30 to store the duration of the burn-in test in real time in response to the start signal. The processor 50 also executes the corresponding operations in response to the signals received from the input unit 40. In detail, when the processor 50 receives the output signal, the processor 50 reads the duration from the storage 30 and then sends the duration to the output unit 60. When the processor 50 receives the setting signal, the duration stored in the storage 30 is read and then set as the default value. When the processor 50 receives the reset signal, the duration stored in the storage 30 is reset.

The output unit 60 outputs the duration received from the processor 50. In this embodiment, the output unit 60 is a display. In other embodiments, the output unit 60 can be a speaker outputting an audio of the duration of the burn-in test.

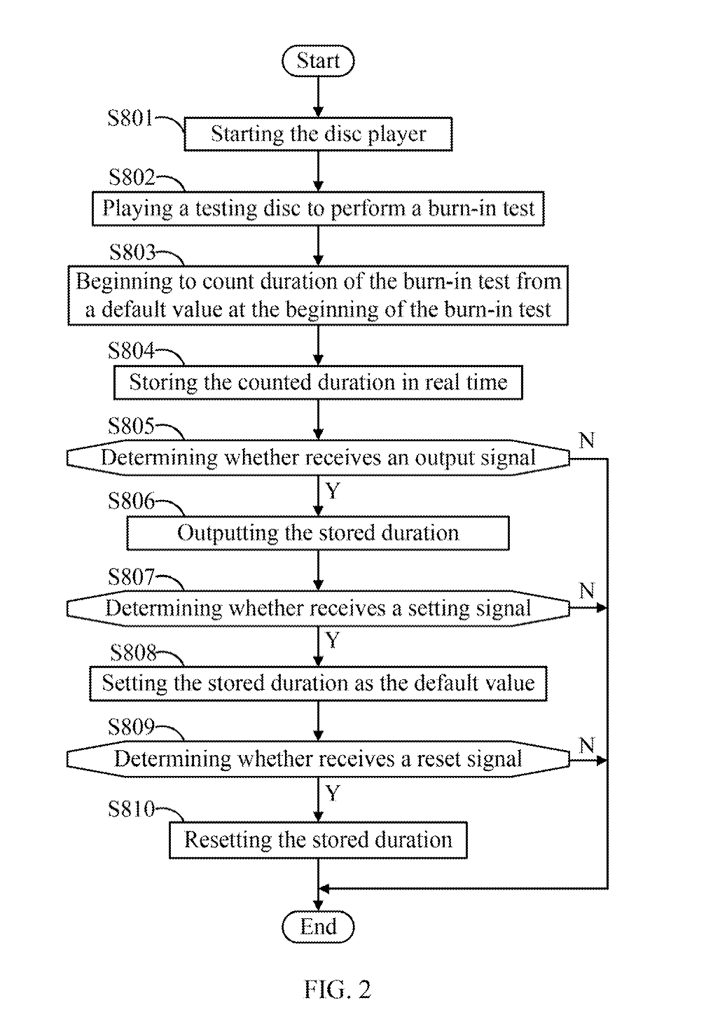

FIG. 2 shows a burn-in test method applied to the disc player 100. The burn-in test method includes the following steps.

In step S801, the disc player 100 is started.

In step S802, the test disc is played to perform the burn-in test. The driving unit 10 sends a start signal to the timing unit 20 and the processor 50 at the beginning of the burn-in test.

In step S803, the duration of the burn-in test is counted from a default value at the beginning of the burn-in test. The timing unit 20 begins to count the duration from the default value in response to the start signal.

In step S804, the duration is stored in real time. The processor 50 controls the storage 30 to store the duration counted by the timing unit 20 in real time in response to the start signal.

In step S805, whether the processor 50 receives the output signal is determined. If the processor 50 receives the output signal, the process goes to step S806. If the processor 50 does not receive the output signal, the process ends. If the burn-in test is interrupted, the user may need to view the duration stored in the storage 30 to determine how long the burn-in test has lasted. The input unit 40 generates the output signal in response to a first user operation.

In step S806, the duration of the burn-in test is outputted. The processor 50 reads the duration from the storage 30 and then controls the output unit 60 to output the duration in response to the output signal.

In step S807, whether the processor 50 receives the setting signal is determined. If the processor 50 receives the setting signal, the process goes to step S808. If the processor 50 does not receive the setting signal, the process ends. If the burn-in test is interrupted because of external malfunctions, the user needs to set the duration as the default value of the timing unit 20 to continue the burn-in test from the point of interruption. The input unit 40 generates the setting signal in response to a second user operation.

In step S808, the duration stored in the storage 30 is read and then set as the default value of the timing unit 20.

In step S809, whether the processor 50 receives the reset signal is determined. If the processor 50 receives the reset signal, the process goes to step S810. If the processor 50 does not receive the reset signal, the process ends. If the burn-in test is interrupted by the malfunctions of the disc player 100 or the burn-in test has finished, the user may need to reset the duration stored in the storage 30. The input unit 40 generates the reset signal in response to a third user operation.

In step S810, the processor 50 resets the duration stored in the storage 30 to zero in response to the reset signal.

It should be noted that: for the aforementioned embodiment of the burn-in test method, the steps S805, S807 and S809 are expressed as a series combination of actions for a brief description, but the skilled person should be aware, the present disclosure is not limited by the limitations described in the operation sequence. Because the user determines the signal the processor 50 receives.

As described above, if the burn-in test is interrupted because of external malfunctions, the user can set the duration stored in the storage 30 as the default value of the timing unit 20 so as to continue the burn-in test from the point of interruption. Thus, the time is saved, and the efficiency of the burn-in test is improved.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A disc player for playing a test disc to perform a burn-in test, the disc player comprising:
a driving unit for playing the test disc and generating a start signal when begin to play the test disc;
a timing unit for counting a duration of the burn-in test from a default value in response to the start signal;
a storage for storing the duration counted by the timing unit in real time;
an input unit for generating an output signal in response to a first user operation; and
an output unit for outputting the stored duration in response to the output signal.

2. The disc player of claim 1, wherein the disc player further comprises a processor, the processor reads the duration from the storage in response to the output signal, and then controls the output unit to output the duration.

3. The disc player of claim 2, wherein the timing unit counts the duration from a default value of zero at the first time, and then the default value is set by the processor.

4. The disc player of claim 3, wherein the input unit further generates a setting signal in response to a second user operation; the duration stored in the storage is read and then set as the default value of the timing unit in response to the setting signal.

5. The disc player of claim 2, wherein the input unit further generates a reset signal in response to a third user operation; the processor resets the duration stored in the storage in response to the reset signal.

6. The disc player of claim 1, wherein the storage is a nonvolatile memory.

7. The disc player of claim 1, wherein the output unit is a display for displaying the duration.

8. The disc player of claim 1, wherein the output unit is a speaker outputting an audio of the duration.

9. A burn-in test method executed by a disc player, the disc player playing a test disc to perform a burn-in test and generating an output signal in response to a first user operation, the burn-in test method comprising:
starting the disc player and playing the test disc to perform the burn-in test;
beginning to count the duration of the burn-in test from a default value at the beginning of the burn-in test;
storing the duration of the burn-in test in real time;
determining whether receives the output signal;
outputting the stored duration of the burn-in test in response to the output signal.

10. The burn-in test method of claim 9, wherein the disc player generates a setting signal in response to a second user operation, the burn-in test method further comprising:
determining whether receives the setting operation;
reading the stored duration and then setting the duration as the default value in response to the setting signal.

11. The burn-in test method of claim 9, wherein the disc player generates a reset signal in response to a third user operation, the burn-in test method further comprising:
determining whether receives the reset signal;
resetting the stored duration in response to the reset signal.
